(19) United States
(12) Patent Application Publication
(10) Pub. No.: US 2009/0282075 A1
(43) Pub. Date: Nov. 12, 2009

(54) SYSTEM AND METHOD FOR IDENTIFYING AND BLOCKING AVATAR-BASED UNSOLICITED ADVERTISING IN A VIRTUAL UNIVERSE

(76) Inventors: Christopher J. Dawson, Arlington, VA (US); Rick A. Hamilton, II, Chrlottesville, VA (US); Brian M. O'Connell, Cary, NC (US); Clifford A. Pickover, Yorktown Heights, NY (US); Keith R. Walker, Austin, TX (US)

Correspondence Address: HOFFMAN WARNICK LLC, 75 STATE ST, 14TH FLOOR, ALBANY, NY, 12207, US

(21) Appl. No.: 12/115,706

(22) Filed: May 6, 2008

(51) Int. Cl. G06F 17/30

(52) U.S. Cl. 707/104.1; 707/E17.009

(57) ABSTRACT

A system and a method for use in a virtual universe (VU) system for identifying offering avatars that may send unsolicited advertisements to receiving avatars is described. The system and method further may allow receiving avatars to reject offerings from such offering avatars. The system and method may utilize reputations of the offering avatars. Receiving avatars may identify spam to the VU system that may record spam information about the identified offering avatar for future processing and may for make the spam information available to other avatars for their use.

### CROSS-REFERENCE TO RELATED APPLICATIONS

This patent application is related to patent application, having attorney docket number END920080053US1, patent application, having attorney docket number END920080054US1, and patent application, having attorney docket number END920080055US1.

### FIELD OF THE INVENTION

Aspects of the present invention provide a system and method for identifying and blocking avatar-based unsolicited advertising in a virtual universe. Using an embodiment of the present invention, advertising and/or offerings for sale of virtual and real goods and services masquerading as computer controlled avatars may be managed.

### BACKGROUND OF THE INVENTION

A computer avatar is a personalized graphic file or rendering that represents a computer user. In virtual worlds, the avatar is a fully rendered interactive character. A virtual world is an animated three-dimensional world created with computer generated imagery (CGI) and other rendering software. In a virtual world a user can interact within the environment by virtue of the avatar. Avatars in a virtual world or virtual universe (VU) have a wide range of business and social experiences, and such experiences are becoming more important as business and social transactions are becoming common in VUs such as Second Life. Second Life is a trademark of Linden Research in the United States, other countries, or both.

As the population of VUs increases, and as the density and intensity of personal activities and commercial transactions increase, greater emphasis will be placed on advertising. Unlike the real world, advertising in VUs is much less constrained by the limiting laws of physics and economics. One advertising mechanism marries unsolicited personal messaging (“spam”) with the concept of automated computer controlled advertising avatars that roam around the VU looking to communicate with potential human avatars.

Avatar-based VU spam has the potential to literally impede or block a user's motion in a VU. It can make the VU run so slowly as to make it unusable (due to the CPU's need to run the spam avatars) and it can block another avatar's line of sight.

### SUMMARY OF THE INVENTION

In general, aspects of the present invention provide a system and a method for identifying offering avatars (spam avatars) used for offering unsolicited advertising messages to receiving avatars. The system and method of the invention provide the ability to quickly identify and, if chosen, to reject offerings from such spam avatars.

The system and method of the present invention utilizes a reputation-based system and method where receiving avatars identify spam to the VU system. The VU system records information about the identified spam received from the receiving avatars for future processing and for making the spam information available to other receiving avatars for their use.

The present invention may further have a method in a virtual universe (VU) system. The VU system may comprise one or more offering avatars, one or more receiving avatars and a reputation table having offering avatar reputation data listings. The method for managing spam avatars may comprise: receiving a message by a receiving avatar from an offering avatar, examining a reputation table, determining whether the reputation table has one or more reputation data listings associated with the offering avatar; and, if so, determining whether the offering avatar is a spam avatar from the one or more reputation data listings associated with the offering avatar.

The present invention may further comprise a computer program product embodied in a computer readable medium for operating in a system comprising a network I/O, a CPU, and one or more databases. The computer program product may for implement a method in a virtual universe (VU) system. The VU system may have one or more offering avatars, one or more receiving avatars and a reputation table having offering avatar reputation data listings. The computer readable medium may have program code for causing a computer system to implement a method for managing spam avatars. The method may comprise: receiving a message by a receiving avatar from an offering avatar, examining a reputation table, determining whether the reputation table has one or more reputation data listings associated with the offering avatar and, if so, determining whether the offering avatar is a spam avatar from the one or more reputation data listings associated with the offering avatar.

The present invention further may comprise a system in a virtual universe (VU) comprising one or more offering avatars and one or more receiving avatars. The system may manage spam avatars and may have a server that may have a VU processing unit and a VU memory. The VU memory may have a a reputation table for storing offering avatar reputation data listings, wherein the server may receive via a communications channel reputation information relating to an offering avatar from a receiving avatar. The VU processing unit may store the offering avatar reputation data in the reputation table and may makes the reputation table available to the one or more receiving avatars so that they may access the offering avatar reputation data in the reputation table.

The present invention further provides a method for deploying a system in a virtual universe (VU) for managing spam avatars. The system may have one or more offering avatars, one or more receiving avatars, a server having a VU processing unit and a VU memory. The VU memory may have a reputation table for storing offering avatar reputation data listings. The server may receive via a communications channel reputation information relating to a offering avatar from a receiving avatar. The VU processing unit may store the offering reputation data in the reputation table and may make the reputation table to the one or more receiving avatars.

Embodiments of the present invention also may provide related systems, methods and/or program products.

### BRIEF DESCRIPTION OF THE DRAWINGS

These and other features of this invention will be more readily understood from the following detailed description of the various aspects of the invention taken in conjunction with the accompanying drawings.

FIG. 1 shows a data processing system suitable for implementing an embodiment of the present invention.

FIG. 2 shows a network that would work with an embodiment of the present invention.

FIG. 3 shows a simple avatar system for implementing the present invention.

FIG. 3A illustrates, in greater detail, an embodiment of the system of the present invention.

FIG. 4 illustrates the steps associated with an embodiment of the method of the present invention.

FIG. 5 shows a depiction of one embodiment of the reputation table of the present invention.

FIG. 6 shows the steps associated with an embodiment of the method of managing the reputation table of the present invention.

FIG. 7 shows a method for adjusting the score thresholds for the various offering avatars.

The drawings are not necessarily to scale. The drawings are merely schematic representations, not intended to portray specific parameters of the invention. The drawings are intended to depict only typical embodiments of the invention, and therefore should not be considered as limiting the scope of the invention.

### DETAILED DESCRIPTION OF THE INVENTION

Aspects of the present invention may provide a system and a method for identifying offering avatars used for offering unsolicited advertising messages, and for responding automatically to offering avatars. The systems and methods of the present invention may provide the ability to quickly identify and, if chosen, to eradicate such offering avatars.

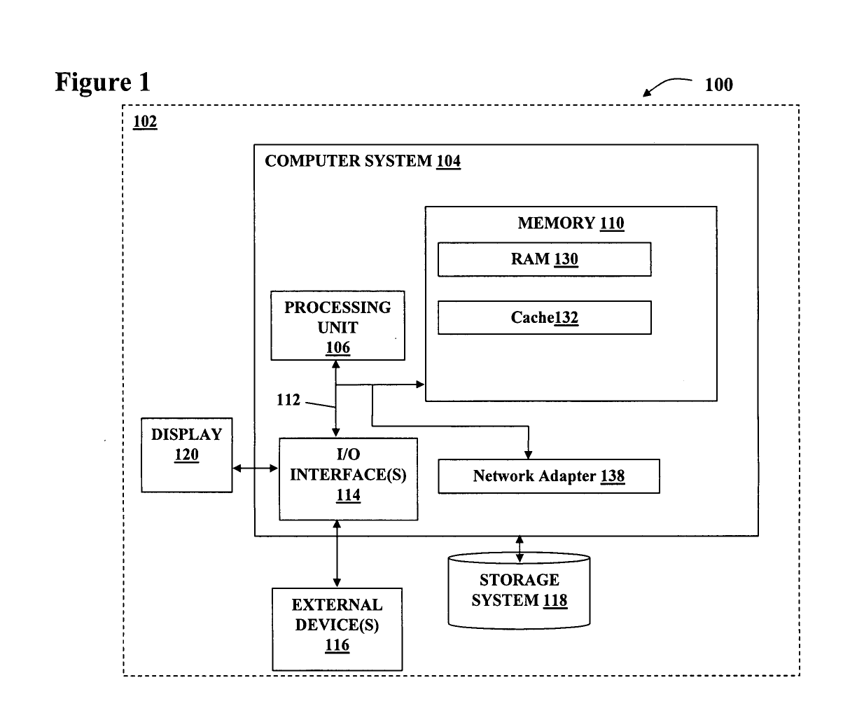

A data processing system 100, such as system 102 shown in FIG. 1, suitable for storing and/or executing program code of the present invention includes a computer system 104 having at least one processor (processing unit 106) coupled directly or indirectly to memory elements through a system bus 112. The memory elements can include local memory (RAM 130) employed during actual execution of the program code, bulk storage (storage 118), and cache memories (cache 132) that provide temporary storage of at least some program code in order to reduce the number of times code must be retrieved from bulk storage 118 during execution. Input/output or I/O devices (external devices 116) (including but not limited to keyboards, displays (display 120), pointing devices, etc.) can be coupled to the system either directly or through intervening I/O controllers (I/O Interface(s) 114).

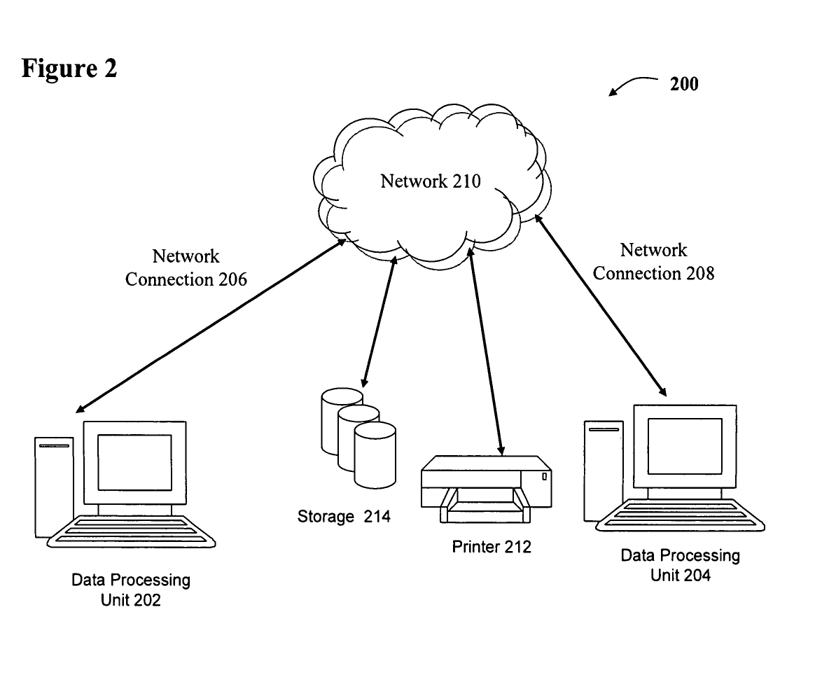

Network adapters (network adapter 138) may also be coupled to a system 200 (FIG. 2) to enable the data processing system (as shown in FIG. 2, data processing unit 202) to become coupled through network connections (network connection 208) to other data processing systems (data processing unit 204), remote printers (printer 212) and/or storage devices (storage 214) through intervening private and/or public networks (network 210). (A computer network is composed of multiple computers connected together using a telecommunication system for the purpose of sharing data, resources and communication. For more information, see http://historyoftheinternet.org/). Modems, cable modem and Ethernet cards are just a few of the currently available types of network adapters. (A network card, network adapter or NIC (network interface card) is a piece of computer hardware designed to allow computers to communicate over a computer network. It is both an OSI layer 1 (physical layer) and layer 2 (data link layer) device, as it provides physical access to a networking medium and provides a low-level addressing system through the use of MAC addresses. It allows users to connect to each other either by using cables or wirelessly.)

The present invention comprises systems and methods of detecting, analyzing, and managing unsolicited advertisements to VU users through unsolicited communication made by human and computer controlled advertising avatars. Both the residents and owners of VUs would benefit from methods to reduce VU spam such as described herein.

Residents (such as in Second Life) are represented in the environment by an avatar. The basic avatar is humanoid in shape which may be customized in a variety of ways:
A series of GUI controls, modifying every aspect of the basic mesh (body shape, skin, hair style etc.).
Creating clothing or buying clothes made by other residents.
Attachments—3D objects intended to supplement or replace body structure, clothes or hair.
Animation Overriders (intended to supplement or replace the stock set of animations) using, for instance, a scripting language such as Linden Scripting Language (LSL) to trigger animations stored in an animation file format such as Biovision Hiearchy (BVH).
Sonic Overriders—using a scripting language such as LSL to trigger sounds such as footsteps, or emotive cues such as laughing and crying.

The result can either be faithful to the original humanoid avatar, or can result in a completely non-humanoid representation of the character. These customizations can be packaged up into a single outfit, with common applications of outfits.

The VU environment provides an opportunity for commercial vendors to market their wares and conduct other commerce with others who are resident in the VU via avatars. Many times, the commercial vendor will customize its avatar so that the avatar has readily distinguishable visual characteristics, audio characteristics or otherwise distinguishable by other of the avatar's assets. One purpose, of course, is to attract the attention of other avatars (potential customers) or to send unsolicited information about a product or service and so on (“advertisement”) so that the commercial vendor's avatar (“offering avatar”) may receive business as a result of the advertisement from one or more recipients of the advertisement (“receiving avatars”). Like all other types of unsolicited marketing via any communication means (e.g., telephone, fax, email, text messaging, etc.), all herein referred as spam, it may be unwanted by one or more of the receiving avatars.

For the purpose of this invention, the term “offering avatar” refers to the avatar advertising a service or product. Furthermore, the term “receiving avatar” refers to an avatar that receives unsolicited information about a product or service. Still yet, any of the components of the present invention could be deployed, managed, serviced, etc., by a service provider who offers to identify spam avatars in a virtual universe (VU) system. The VU system may have one or more offering avatars, one or more receiving avatars and a reputation table having offering avatar reputation data listings.

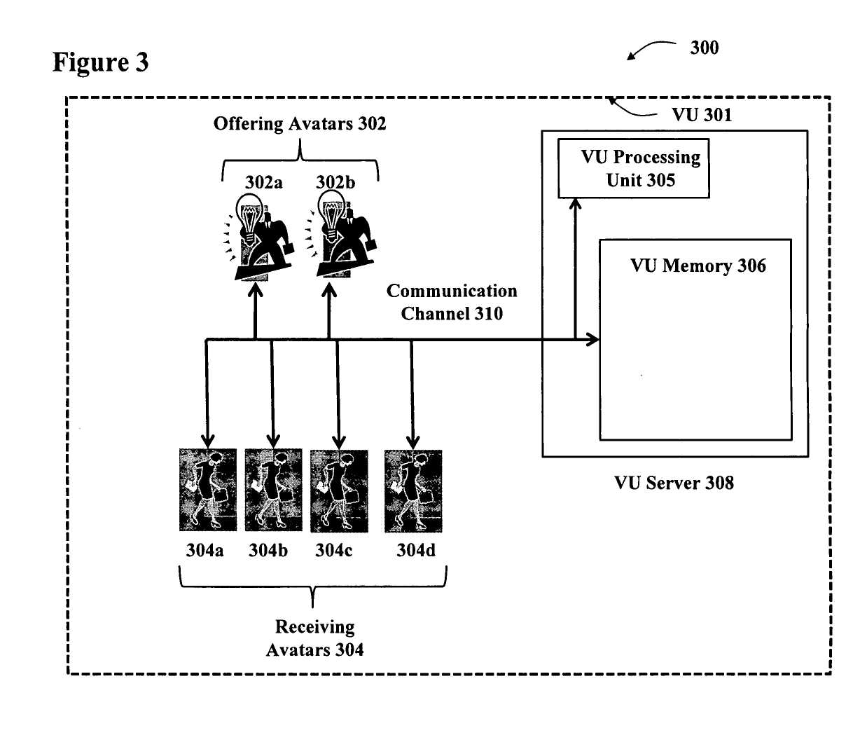

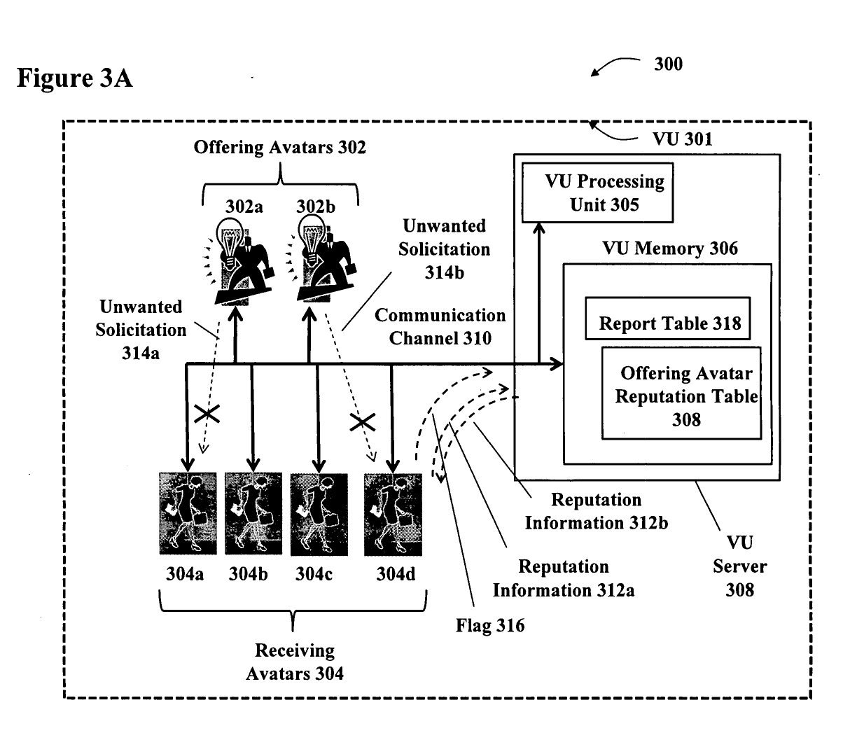

A simple avatar system 300 for implementing the present invention is shown in FIG. 3, and includes a VU 301 having a VU processing unit 305, a VU memory 306 for storing information about the VU 301 and activities and avatars within the VU 301, one or more offering avatars 302 (302a, 302b) and one or more receiving avatars 304 (304a, 304b, 304c, 304d). There can be any number of offering avatars 302 and receiving avatars 304. The offering avatars 302 and the receiving avatars 304 can communicate with one another, amongst themselves and with VU memory 306 or other assets (such as avatar attachments, vehicles, buildings, furniture, sculpture or other items) in VU 301 via communications channel 310. Both offering avatars 302 and receiving avatars 304 are considered to be VU residents.

As noted above, there is a need for the receiving avatars to have the ability to identify the offering avatars so that the receiving avatars may block the unsolicited communications from the offering avatars should the receiving avatars so desire. The present invention provides a system and method for identifying offering avatars further described hereinbelow.

The system and method is reputation-based where receiving avatars identify spam. As discussed above, the reputation-based system relies on the opinion of VU residents to identify offering avatars when a receiving avatar receives an unwanted solicitation from an offering avatar, or otherwise suspects an avatar is an offering avatar. As shown in FIG. 3A, VU Memory 306 has an offering avatar reputation table 308 for storing offering avatar reputation information either preloaded or gathered from receiving avatars 304 via communication channel 310 (reputation information 312a). This reputation information is distributed to receiving avatars 304 from VU memory 306 and offering avatar reputation table 308 via communication channel 310 (reputation information 312b) for later use by receiving avatars 304. It should be noted that reputation information 312b could as easily be stored in a central location in the VU. Receiving avatars 304 may use this reputation information 312b to reject an unwanted solicitation from an offering avatar. For instance, as shown in FIG. 3A, offering avatar 302a sends an unwanted solicitation 314a to receiving avatar 304a. Receiving avatar 304a parses unwanted solicitation 314a to find information about the sender such as the unique identifier, or UUID, and compares the UUID against the UUIDs of known offering avatars (stored in reputation information 312b stored either locally in receiving avatar 304a or in VU server 308) to reject the unwanted solicitation 314a.

Receiving avatars may choose which solicitations to accept or reject. For instance, a receiving avatar may choose to accept all solicitations from all offering avatars, to accept solicitations from particular offering avatars and to reject all solicitations from all other offering avatars, or to reject all solicitations from all offering avatars.

There are cases where reputation information 312b does not have details of an offering avatar as shown in FIG. 3A where offering avatar 302b sends an unwanted solicitation 314b to receiving avatar 304d. Receiving avatar 304d examines its stored reputation information 312b and determines that it has no reputation information relating to offering avatar 302b. Receiving avatar 304d then determines that the message is an unwanted solicitation and may reject (or accept) unwanted solicitation 314b. If receiving avatar 304d has the authority to flag offering avatars and chooses to do so, it sends a flag 316 to VU memory 306. VU processing unit 305 gathers reputation information regarding offering avatar 302b such as the unique identifier of the offering avatar 302b (UUID), along with any additional information, such as time of incident, recording of last n seconds of interaction between the two avatars, text provided by the receiving avatar, and any other information of interest and stores it in offering avatar reputation table 308. Reputation information 312b is updated and redistributed to the receiving avatars.

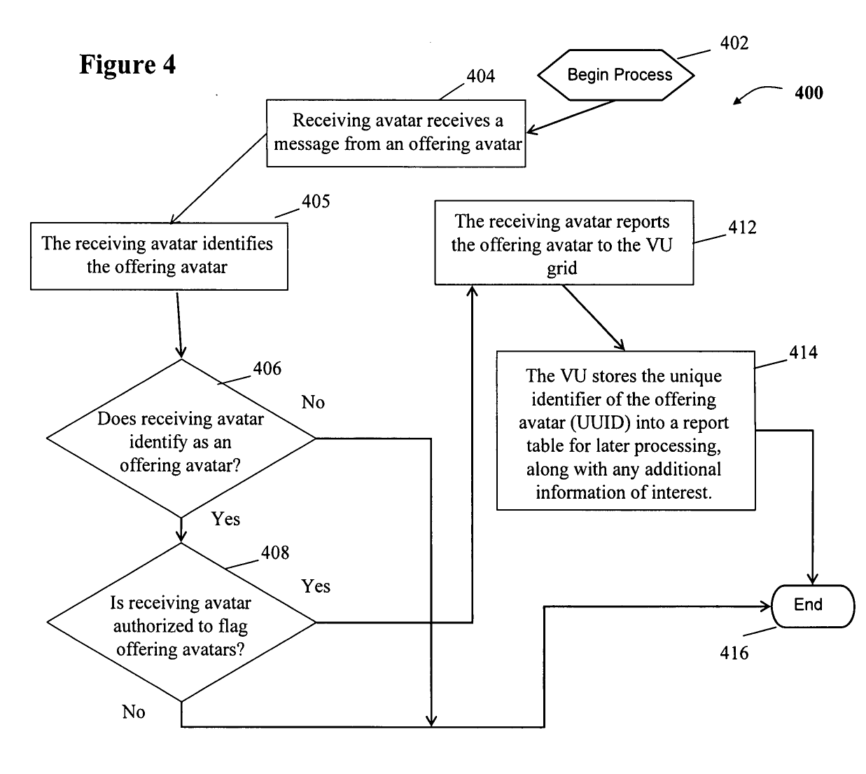

A method 400 for this process is shown in FIG. 4 which begins at step 402 and continues to step 404 where the receiving avatar receives a message from an offering avatar. At step 405, receiving avatar identifies the offering avatar by examining message information such as the UUID. At step 406, the receiving avatar compares the UUID against UUIDs of known offering avatars. If not, it examines the message to determine whether it is an unsolicited message and, if not, the process ends at 416. If so, it is determined whether the receiving avatar is authorized to flag offering avatars. If not, the process ends at 416. If so, at step 412, the receiving avatar reports the offering avatar to the VU system or grid. This was discussed previously with relation to FIG. 3A. This can be done by, for instance, clicking on the offering avatar, and then selecting an option to “Report advertising avatar.” At step 414, the VU grid stores the unique identifier of the offering avatar (UUID) into a report table (such as in the Offering Avatar Reputation Table 308 in VU memory 306 discussed in FIG. 3A) for later processing, along with any additional information, such as time of incident, recording of last n seconds of interaction between the two avatars, text provided by the receiving avatar, and any other information of interest as discussed above.

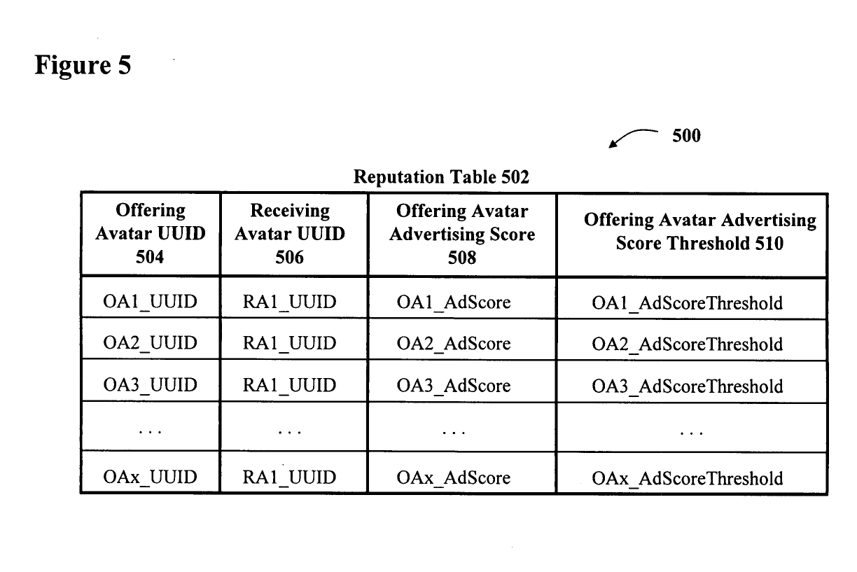

FIG. 5 illustrates an exemplary reputation table 502. Reputation table 502 can also be named “black list” due to the nature of its use. Reputation table 502 may contain any number of fields but in the present example, it contains reputation data listings for a number of offering avatars (OA1, OA2, OA3, . . . OAx) identified by the corresponding OA_UUID in column Offering Avatar UUID 504. Reputation table 502 further has columns Receiving Avatar UUID 506, Offering Avatar Advertising Score 508 and Offering Avatar Advertising Threshold Score 510. In the present example table 502, receiving avatar (RA1) having RA1_UUID has entries for the AdScore and the AdScore Threshold for offering avatars (OA1, OA2, OA3, . . . OAx). These values are used by RA1 to determine the steps it should take an offering avatar (e.g., OA1) is identified and the AdScore associated with OA1 meets or exceeds the OA's AdScore Threshold.

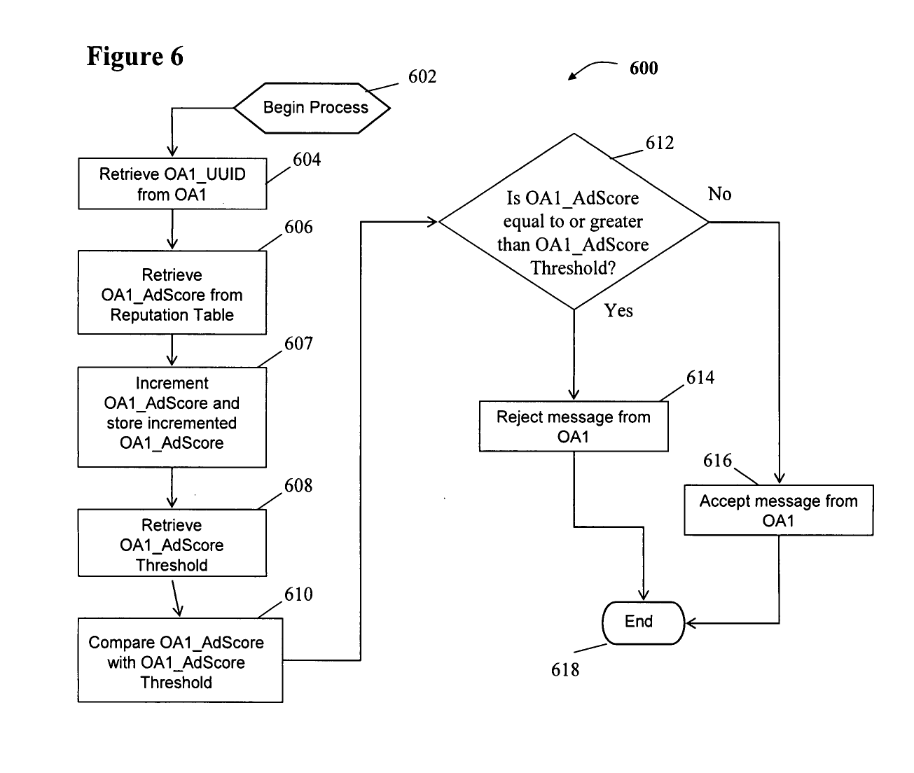

FIG. 6 illustrates the process associated with utilizing the Reputation Table 502 which starts at 602 when a Receiving Avatar, such as RA1, receives an unsolicited message from an Offering Avatar, such as OA1. At step 604, RA1 retrieves the UUID of OA1 from OA1. At 606, RA1 retrieves OA1_AdScore from the reputation table. At 607, OA1_AdScore is incremented by RA1 and updated in reputation table. It should be noted that OA1_AdScore may be incremented by other receiving avatars if they get contacted by OA1. In this way, OA1_AdScore represents a score relating to OA1's activity in the VU with respect to all receiving avatars, not merely just RA1.

At 608, RA1 retrieves the OA1_AdScore Threshold of OA1 from the reputation table and, at 610, RA1 compares OA1_AdScore with OA1_AdScore Threshold. At 612, RA1 determines whether OA1_AdScore is equal to or greater than OA1_AdScore Threshold and, if so, at 614, RA1 rejects the message from OA1. If not, RA1 accepts the message at 616 and the process ends at 618. Of course, RA1 may choose a different course of action than “Reject” or “Accept” should OA1_AdScore meet or exceed OA1_AdScore Threshold.

As noted above, if there is no entry for OA1 and if RA1 has flagging authority, RA1 can flag OA1 and an entry can be created in reputation table 502.

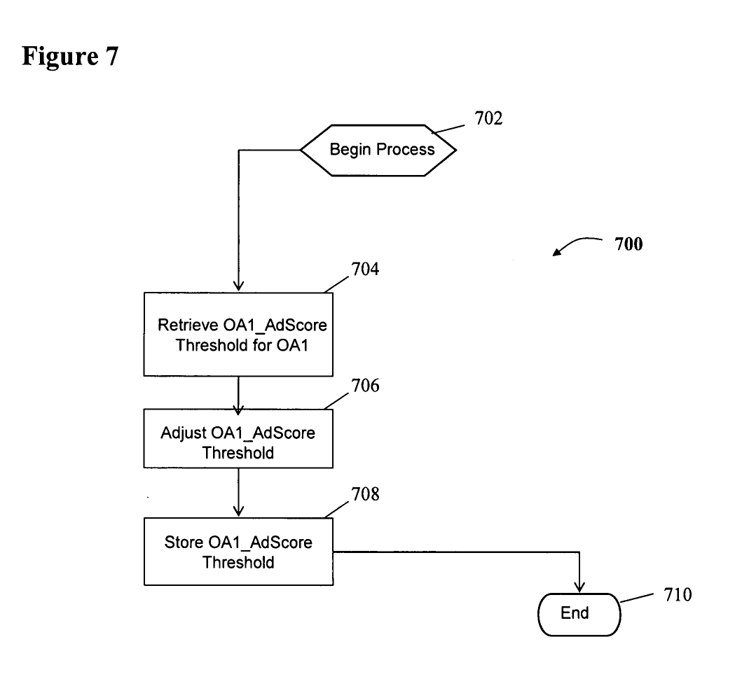

As noted above, receiving avatar may adjust the AdScore Thresholds for the various offering avatars. This process 700 of FIG. 7 starts at 702 and, at 704, the receiving avatar, e.g., RA1, retrieves AdScore Threshold for an offering avatar, e.g., OA1. At 706, RA1 adjusts AdScore Threshold and, at 708, stores updated AdScore Threshold in the reputation table.

It should be understood that the present invention is typically computer-implemented via hardware and/or software. As such, client systems and/or servers will include computerized components. Such components typically include (among others), a processing unit, a memory, a bus, input/output (I/O) interfaces, external devices, etc.

While shown and described herein as a system and method for identifying avatar-based unsolicited advertising in a virtual universe, it is understood that the invention further provides various alternative embodiments. For example, in one embodiment, the invention provides a computer-readable/useable medium that includes computer program code to enable a computer infrastructure to identify spam avatars in a virtual universe (VU) system. The VU system may have one or more offering avatars, one or more receiving avatars and a reputation table having offering avatar reputation data listings. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.), and/or as a data signal (e.g., a propagated signal) traveling over a network (e.g., during a wired/wireless electronic distribution of the program code).

The method implemented the computer readable/usable medium may have the following steps: receiving a message by a receiving avatar from an offering avatar; examining a reputation table; determining whether the reputation table has one or more reputation data listings associated with the offering avatar; and if so, determining whether the offering avatar is a spam avatar from the one or more reputation data listings associated with the offering avatar.

In another embodiment, the invention provides a computer-implemented method for blocking avatar-based unsolicited advertising in a virtual universe In this case, a computerized infrastructure can be provided and one or more systems for performing the process steps of the invention can be obtained (e.g., created, purchased, used, modified, etc.) and deployed to the computerized infrastructure. To this extent, the deployment of a system can comprise one or more of (1) installing program code on a computing device, such as computer system from a computer-readable medium; (2) adding one or more computing devices to the computer infrastructure; and (3) incorporating and/or modifying one or more existing systems of the computer infrastructure to enable the computerized infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

In another embodiment, the invention provides a business method that performs the process steps of the invention on a subscription, advertising, and/or fee basis. That is, a service provider, such as a Solution Integrator, could offer to identify offering avatars. In this case, the service provider can create, maintain, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method in a virtual universe (VU) system, the VU system comprising one or more offering avatars, one or more receiving avatars and a reputation table having offering avatar reputation data listings, the method comprising:
receiving a message by a receiving avatar from an offering avatar;
examining the reputation table;
determining whether the reputation table has one or more offering avatar reputation data listings associated with the offering avatar; and
if the reputation table has one or more offering avatar reputation data listings associated with the offering avatar, determining whether the offering avatar is a spam avatar from the one or more offering avatar reputation data listings associated with the offering avatar.

2. The method of claim 1 wherein if the reputation table does not have one or more offering avatar reputation data listings associated with the offering avatar, the method further comprises creating a listing for the offering avatar along with offering avatar reputation data for the offering avatar.

3. The method of claim 2, the VU system further comprising a VU server, the VU server comprising the reputation table and further wherein the creating a listing step comprises the receiving avatar flagging the offering avatar to the VU server.

4. The method of claim 3 further comprising storing offering avatar reputation data in the VU server relating to the offering avatar including an offering avatar unique identifier.

5. The method of claim 1 wherein the VU system further comprises a reputation memory and wherein the method further comprises periodically distributing offering avatar reputation data to the receiving avatar.

6. The method of claim 1 wherein the offering avatar reputation data listings have advertising scores associated with the one or more offering avatars and wherein the offering avatar reputation data listings have advertising score thresholds.

7. The method of claim 6 wherein the advertising score thresholds are associated with each offering avatar and each receiving avatar.

8. The method of claim 7 further comprising allowing each receiving avatar to set the advertising score thresholds associated with each offering avatar.

9. The method of claim 1 wherein the reputation data listings have advertising scores associated with the one or more offering avatars and wherein, if, in the determining step, it is determined that the offering avatar is a spam avatar, the method further comprises incrementing the advertising score of the offering avatar.

10. The method of claim 1 wherein the reputation data listings have advertising scores associated with the one or more offering avatars and, if, in the determining step, it is determined that the first offering avatar is not a spam avatar, the method further comprises decrementing the advertising score of the offering avatar.

11. A computer program product embodied in a computer readable medium for operating in a system comprising a network I/O, a CPU, and one or more databases, for implementing a method in a virtual universe (VU) system, the VU system comprising one or more offering avatars, one or more receiving avatars and a reputation table having offering avatar reputation data listings, the computer readable medium comprising program code for causing a computer system to implement a method wherein the method comprises:
receiving a message by a receiving avatar from an offering avatar;
examining a reputation table;
determining whether the reputation table has one or more offering avatar reputation data listings associated with the offering avatar; and
if the reputation table has one or more offering avatar reputation data listings associated with the offering avatar, determining whether the offering avatar is a spam avatar from the one or more offering avatar reputation data listings associated with the offering avatar.

12. The computer program product of claim 11, the method further comprising, if the reputation table does not have one or more offering avatar reputation data listings associated with the offering avatar, creating an offering avatar reputation listing for the offering avatar along with reputation information for the offering avatar.

13. The computer program product of claim 12 wherein the VU system further comprises a VU server and further wherein, in the method, the creating a listing step further comprises flagging the first offering avatar to the VU server.

14. The computer program product of claim 13 wherein the method further comprises the VU server storing offering avatar data associated to the offering avatar including an offering avatar unique identifier to the one or more receiving avatars.

15. The computer program product of claim 11 wherein the reputation memory is located in a VU server and the method further comprises periodically distributing offering avatar reputation data to the one or more receiving avatars.

16. The computer program product of claim 11 wherein the reputation data listings have advertising scores associated with the one or more offering avatars and wherein the reputation data listings have advertising score thresholds.

17. The computer program product of claim 16 wherein the advertising score thresholds are associated with each offering avatar and each receiving avatar.

18. A system for managing offering avatars in a virtual universe (VU) comprising one or more offering avatars and one or more receiving avatars, the system comprising:
a server having:
a VU processing unit;
a VU memory comprising a reputation table for storing offering avatar reputation data; and
a communications channel for providing communications capabilities within the server, wherein the server receives from a receiving avatar via the communications channel offering avatar reputation data relating to an offering avatar, wherein the VU processing unit stores the offering avatar reputation data in the reputation table and makes the reputation table available to the one or more receiving avatars for accessing the offering avatar reputation data.

19. The system of claim 18 wherein the server periodically distributes the offering avatar reputation data in the reputation table to the one or more receiving avatars.

20. The system of claim 18 wherein the server receives reports from the one or more receiving avatars having information relating to the one or more offering avatars and the VU memory further has a report table for storing the reports.

21. A method for deploying computing infrastructure, comprising integrating computer-readable code into a computing system, wherein the code in combination with the computing system is capable of performing a process of identifying and blocking offering avatars, the computing system having a computer having a processing unit; and a memory comprising a reputation table for storing offering avatar reputation data listings, the process comprising:
providing one or more offering avatars;
providing one or more receiving avatars;
receiving at the computer from a receiving avatar, via a communications channel, offering avatar reputation data relating to an offering avatar;
storing by the processing unit in the reputation table the offering avatar reputation data; and
making the reputation table available to the one or more receiving avatars for receiving the offering avatar reputation data.

22. The method of claim 21 wherein the process further comprises periodically distributing to the one or more receiving avatars by the computer the offering avatar reputation data.

23. The method of claim 21 wherein the process further comprises:
receiving reports from the one or more receiving avatars having offering avatar reputation data relating to the one or more offering avatars; and
storing the received reports in a report table in the memory.

24. The method of claim 23 wherein the process further comprises processing by the processing unit the reports and storing the offering avatar reputation data in the reputation table.
